(19) United States
(12) Patent Application Publication
(10) Pub. No.: US 2023/0388567 A1
(43) Pub. Date: Nov. 30, 2023

(54) A SYSTEM AND METHOD FOR ASSIGNING A MONETARY COST FOR DIGITAL MEDIA DISPLAY SESSIONS THROUGH A PAY PER INFERRED VIEW CHARGING MODEL

(71) Applicant: Albert Stevens, Augustine, FL (US)

(72) Inventor: Albert Stevens, Augustine, FL (US)

(21) Appl. No.: 18/249,824

(22) PCT Filed: Oct. 21, 2021
(86) PCT No.: PCT/US21/71957

§ 371 Date: Apr. 20, 2023

(51) Int. Cl. H04N 21/2543; H04N 21/442; H04N 21/258; H04N 21/25; H04N 21/234

(52) U.S. Cl. CPC H04N 21/25435; H04N 21/44204; H04N 21/41422; H04N 21/251; H04N 21/23418; H04N 21/25883

(57) ABSTRACT

A system and method for assigning a monetary cost for digital media display sessions through a pay-per-inferred-view charging model, including non-transitory computer-readable storage media, a processing system, and a media display system. The media display system comprises a neural network, an interface system, including a communications interface. The interface system communicates with the media display system and program instructions stored on the computer-readable storage media that, when executed by the processing system, direct the processing system in response to receiving, via the communications interface, media display session data from the media display system. The media display session data includes audience viewership information to determine composite audience viewership scores from the audience entity quality rating for each unique audience entity and compute a session cost for the media display session.

### RELATED APPLICATIONS

This application is a national phase application of and claims priority under 35 U.S.C. § 371 of PCTPCT Patent Application Serial No. PCT/US21/71957 (Attorney Docket No. 6403.00001) filed on Oct. 21, 2021 and titled A SYSTEM AND METHOD FOR ASSIGNING A MONETARY COST FOR DIGITAL MEDIA DISPLAY SESSIONS THROUGH A PAY PER INFERRED VIEW CHARGING MODEL. The content of this application is incorporated herein by reference.

### BACKGROUND

Although current charging models exist within the Digital-Out-Of-Home (DOOH) industry, they do not rely on actual audience viewership data. The recent advancements in Artificial Intelligence/Machine Learning (AI/ML) visual recognition techniques along with visual object sensor technology, such as RADAR, LIDAR, and cameras, have enabled the possibility of obtaining accurate audience viewership from advertisement media displayed on a DOOH media display system, such as a digital billboard, kiosk, mobile vehicle display, mobile phone, or tablet.

### BRIEF SUMMARY

Existing technologies and systems used for assigning a monetary cost for media display sessions on media display systems Therefore, it would be advantageous to incorporate a system and method for assigning a monetary cost for digital media display sessions through a pay-per-inferred view (PPIV) charging model into one such system as well.

A system and method is described for assigning a monetary cost for digital media display sessions through a pay-per-inferred-view charging model, comprising: non-transitory computer-readable storage media; a processing system; one or more media display systems, wherein the one or more media display systems comprises a neural network; an interface system, including a communications interface, wherein the interface system communicates with the one or more media display systems; and program instructions stored on the computer-readable storage media that, when executed by the processing system, direct the processing system to: in response to receiving, via the communications interface, media display session data from a media display system, wherein the media display session data includes at least audience viewership information: determine composite audience viewership scores from the audience entity; and compute a session cost for the media display session.

Additional embodiments of this system comprise: further instructions that when executed by the processing system, further direct the processing system to: calculate demographic factors for each unique audience entity and use the demographic factors to adjust the individual value factor for each audience entity quality rating in accordance with targeting properties of the media display session; further direct the processing system to: in response to calculating a session cost: charge or request monetary funds or credits from the media owner user account associated with the advertisement media displayed within the media display session; further direct the processing system to: in response to receiving monetary funds or credits from the media owner user account: distribute monetary funds or credits to the one or more client user accounts or entities associated with the media display system which hosted the media display session; further direct the processing system to: in response to receiving monetary funds or credits from the media owner user account: distribute monetary funds or credits to the entity associated with hosting the software application/service; and further direct the processing system to: send the session cost for the digital media display session to a data store, wherein said data store provides the session cost data to a web host that allows users to view the session cost.

Note: This Brief Summary is provided to introduce a selection of concepts in a simplified form that are further described below in the Detailed Description. The Brief Summary is not intended to identify key features or essential features of the claimed subject matter, nor is it intended to be used to limit the scope of the claimed subject matter.

### BRIEF DESCRIPTION OF THE DRAWINGS

FIG. 1 shows a high-level example of system/component environment in which some implementations of systems and techniques for a PPIV charging model can be carried out.

FIG. 2 shows example embodiments of media display systems for which a PPIV charging model could be implemented within.

FIG. 3 shows an example diagram of the object sensor data points of several objects as shown from an outbound viewpoint of a media display system.

FIG. 4 shows an example process flow for the overall process of the implementation of a PPIV charging model.

FIG. 5 shows an example embodiment of a system/component configuration for which a PPIV charging model could be implemented for a media display system.

FIG. 6 shows a high-level process flow for activities related to a PPIV charging model for a media display system.

FIG. 7 shows an example interface that a user-operator can view media display session cost and audience viewership metrics.

FIG. 8 shows an example interface that a user-operator can view their monetary balance, withdraw monetary funds, update their bank account information, or make a payment.

FIG. 9A depicts an example representation of a session store, organized as a table in a relational database.

FIG. 9B depicts an example representation of a user store, organized as a table in a relational database.

FIG. 10 shows a block diagram illustrating components of a computing device or system used in some embodiments of techniques, systems, and apparatuses for which a PPIV charging model could be implemented for media display systems.

### DETAILED DESCRIPTION

The Digital-Out-Of-Home (DOOH) industry is expanding at a rapid rate due to a myriad of technological advancements which have reduced manufacturing costs, scaled down component size, and increased power and efficiency. Media display systems are now able to display in outdoor environments without being affected by outside elements such as sunlight. This technology is replacing traditional print media due to the various advantages in which it provides, such as the ability to adapt display content in real-time. Artificial intelligence/machine learning (AI/ML) visual recognition techniques along with visual object sensor technology, such as RADAR, LIDAR, and cameras, have also undergone major improvements over the recent years. This combined technology can now be implemented within a DOOH media display system, such as a digital billboard, kiosk, or mobile vehicle display system, for audience viewership verification of advertisements. Therefore, it would be advantageous to incorporate a system and method for assigning a monetary cost for digital media display sessions through a pay-per-inferred view (PPIV) charging model into one such system.

Existing technologies for assigning a monetary cost to a media displayed on media display systems have lacked methods and structure to support the accurate estimation of audience viewership within environments including various dynamic parameters involving movement. This is now possible with the use of obtaining data through object sensors such as cameras, RADAR, and LIDAR, and analyzing that data through a neural network. Systems are presented to facilitate a monetary cost to audience viewership of media display sessions displayed on media displays systems. The technological features described herein support assigning individual viewership costs and a total session cost to a media display session based on the fusion of audience estimation data collected in dynamically changing physical, real-world viewing environments. Further technical advantages are described below with respect to detailed embodiments. This description is not intended to be limited to the details described and shown since various technical and structural modifications can be made therein without departing from the spirit of the invention. Additionally, well-known elements of exemplary embodiments of the invention will not be described in detail or will be omitted so as not to obscure the relevant details of the invention.

Innovations, such as artificial intelligence/machine learning (AI/ML), can now be used to identify audience viewership of the media content being displayed on these mediums. With this new combination of technologies, there is a possibility of a system for assigning a monetary cost for digital media display sessions hosted on media display systems, which is based on audience viewership. Such an implementation can be performed through a Pay-Per-Inferred-View (PPIV) charging model that uses AI/ML verification techniques to infer audience views and associate a monetary cost for each unique view. From each unique audience view inferred within a media display session, a total monetary cost calculation can be generated. The owner of the media that was displayed within the media display session would incur this cost. Finally, the monetary funds obtained from the media display session would be distributed to the owner or user of the media display system as well as the full system/service provider.

Using a PPIV charging model, a more accurate representation of audience viewership can be included with a media display session so that a media owner has a higher assurance that their media was actually viewed and the media owner can only pay for each view that was inferred. This charging model establishes a fair price for media displays sessions, ensures media purchasers are only paying for actual viewership, and helps media purchasers acquire their exact audience reach without exceeding their budget. This model discounts false positive views as opposed to other methods that rely only on GPS location data.

Machine learning performs exceedingly well when it comes to visual recognition. Methods such as frame-by-frame picture or video analysis can be used with labeled data sets to accurately infer various objects and object actions. A common use case example for visual recognition technology is facial recognition. Visual data, such as object orientation, can be analyzed in various ways and determined with a high probability of inference. This technique can be performed in a secure manner that ensures the public's privacy.

Audience viewership, in the context of this invention, can include people and vehicles such as automobiles or other forms of human or goods transports. Parameters such as detecting the side or front portions of an object can be used to identify an audience view. The angle of an object in accordance to the media display system, along with proximity, duration of engagement, demographic information, and obstruction factors can all be fused together to rank each inferred view. After each unique audience view is ranked according to factors previously mentioned, they can then be assigned with a monetary cost.

The accuracy of actual viewership is vital to establishing fair prices on media being displayed on digital devices. Pay-Per-View (PPV) is a charging model used to view media on digital networks such as television, satellite, or the Internet. It can also be used to calculate total audience viewership of the media content in which it sells. This can be inaccurate due to multiple people potentially watching on a single display or a purchaser potentially not viewing the media content. Pay Per Click (PPC) is a payment system that works with web content on the Internet and charges media purchasers based on how many times a media link gets clicked. The problem associated with this system is that many users accidentally click on media links and this contributes to false positives.

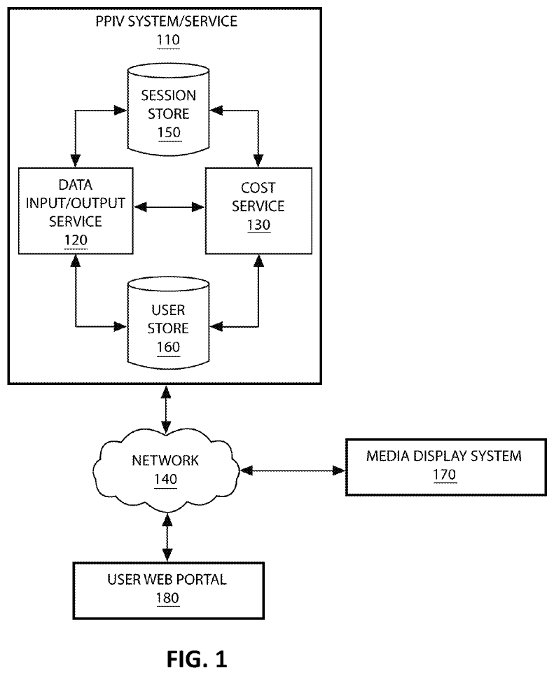

Generally, PPIV system/service 110 is composed of computing system elements, elements for transferring, inputting, outputting, and viewing data, elements displaying media and monitoring audience viewership, elements for associating a monetary cost with audience viewership, and elements for requesting, receiving, and distributing monetary funds. It should be noted that PPIV system/service 110 has many possible configurations, numerous examples of which are described in more detail below. PPIV system/service 110 performs various processing activities such as receiving audience viewership data from a media display system 170, determining audience viewership scores, computing a media display session cost, requesting, charging, and receiving funds, distributing funds, and sending session cost data to data store(s). This broad description is not intended to be limiting, as the various processing activities of PPIV system/service 110 are described in detail subsequently in relation to FIGS. 1-10.

Terms and definitions mentioned herein are listed for the purpose of clarity. Terms mentioned herein pertaining to users and system components are described as follows. The term “data” refers to any computer generated information that can be digitally processed and stored as computer files. The term “PPIV” refers to Pay-Per-Inferred-View, which is a new term involving both payments for audience views and AI/ML inference to detect audience views. The term “audiovisual display unit” refers to any digital medium that projects or displays an image or video. The term “object sensor” refers to any sensor that can view, detect, or record objects in a real-world environment, such as a camera, RADAR, or LIDAR component. The term “media display system” refers to any computing system with at least an audiovisual display unit and a processing system. The term “media display session” refers to data obtained on a media display system, specifically, data including at least audience viewership information. The term “media owner/purchaser” refers to any entity that owns or has purchased media, wherein media refers to one or more digital image, video, or audio file. A media owner/purchaser could also be a user and have access to certain aspects of the system. The term “user” refers to either a media display system owner/operator or a media owner/purchaser. An example of a media display system owner/operator user would be a rideshare driver or vehicle with a media display system attached to or embedded within the vehicle.

Terms mentioned herein pertaining to audiences and monetary values are described as follows. The term “audience entity” refers to any human object or vehicle object that could be containing a human object. The term “viewership” refers to any audience object viewing, looking towards, or engaging with a media display system. The term “audience quality rating” refers to the ranking of an individual or group of audience entity's viewership of a media display system, which is based on various factors described herein. The term “charging model” refers to system or process dedicated to assigning a monetary value, charging an entity said monetary value, and distributing said monetary value. The term “monetary cost” refers to a debt that must be paid with a specified currency. The term “fund” refers to a specified currency.

Terms mentioned herein pertaining to artificial intelligence/machine learning (AI/ML) are described as follows. The term “neural network” refers to a series of algorithms trained to perform complicated computation operations or processes in a fast and efficient manner, similar to mathematical models of the brain. Specifically, in regards to this invention, the one or more neural network is trained to detect audience viewership from a media display system, collect audience viewership data, and associate monetary costs with audience viewership data. The term “AI/ML trainer” refers to any system including software and/or hardware dedicated to improving operations or processes of the neural network or AI/ML models. The term “AI/ML hardware/compute” refers to any processing system used to power the neural network. The term “AI/ML model” refers to software containing layered, interconnected mathematical processes that mimic the human brain processes and will be feed into the neural network. The term “inference” refers to data inferred from the neural network, specifically, audience viewership and media display session cost.

FIG. 1 shows a high-level example of a system/component environment in which some implementations of systems and techniques for assigning a monetary cost with a digital media display session can be carried out. In brief, the PPIV system/service 110 has underlying services, including the data input/output service 120 and the cost service 130, that work collaboratively to send and receive data to and from a media display system 170, a user web portal 180, a user store 160, and a session store 150. The PPIV system/service 110 also contains programming instructions used to calculate media display session cost, charge media owner(s)/purchaser(s), and pay media display system 170 owner(s)/users and service providers. The PPIV system/service 110 stores all of this data within data stores including a user store 160 and a session store 150. More of less data stores can be used in other embodiments and the data stores mentioned herein are used for exemplary purposes. The user web portal 180 allows users access to view media display session data, purchase media display sessions, pay for media display sessions, receive payments for media display sessions, and manage user account details. Both the user web portal 180 and the media display system 170 connect to the PPIV system/service 110 via a network 140. The session store 150 contains all data related to any given media display session hosted on a media display system 170, including audience estimation data derived from a neural network used to infer each unique audience view. The user store 160 contains all user data that relates to a media display session as a client or a host. The data input/output service 120 sends and receives data from the data stores, the cost service 130, media display system 170, and user web portal 180. The cost service 130 determines individual prices per inferred audience views for each unique audience view and calculates a total session cost by totaling the sums for each unique audience view. The cost service 130 also handles payment transactions including charging and payment distribution for media display sessions as well as user withdraws or deposits.

In some embodiments, other subcomponents/subservices of 110, such as data input/output service 120, performs activities related to sending and receiving data to and from a media display system 170. The cost service 130 performs activities related to processing a media display session data package received from a media display system 170 containing, for example, audience estimation data and other telemetry. A media display session package may be stored by the data input/output service 120 in a session store 150.

Either or both services 120 and 130, and/or other subcomponents of the PPIV system/service 110 may interact with a user data store 160, which contains user-operator account data, configuration data, and other properties of each of the digital media display mediums registered to use the PPIV service.

Either or both services 166 and 164, and/or other subcomponents of the PPIV system/service 110 may interact with a session store 150, which contains audience statistics from media display sessions.

Network 140 can include, but is not limited to, a cellular network (e.g., wireless phone), a point-to-point dial up connection, a satellite network, the Internet, a local area network (LAN), a wide area network (WAN), a Wi-Fi network, an ad hoc network, a Bluetooth network, or a combination thereof. Such networks are widely used to connect various types of network elements, such as hubs, bridges, routers, switches, servers, and gateways. The network 140 may include one or more connected networks (e.g., a multi-network environment) including public networks, such as the Internet, and/or private networks such as a virtual private network or secure enterprise private network. Access to the network 140 may be provided via one or more wired or wireless access networks as will be understood by those skilled in the art. The PPIV system/service 110, media display system 170, and user web portal 180 may connect to network 140 by employing one or more elements of a communications interface. Computing system and device components supporting network connectivity via a communications interface are described in detail with respect to FIG. 1.

User web portal 180 is a web application that can be accessed over a network 140 and viewed through a mobile application, a web browser application, or a dedicated computing application. Non-limiting examples and embodiments of user web portal 180 mediums include a computing system, desktop computer, mobile device, tablet device, mobile phone, wearable, an interface screen that is dash-mounted inside the mobile vehicle, and in-dash interface device installed in the mobile vehicle running software that provides the user interface elements. Examples of a client interface include devices that can use a web browser to access a web page, or that have an “app” (or other software applications), to connect to a cloud service interface over the network 140. User web portal 180 may interact with subcomponents of the PPIV system/service 110, such as a user store 160, to modify user-operator account information, a session store 150, to receive updated session information, data input/output service 120, to send and receive data from each subcomponent of the PPIV system/service 110, and cost service 130, to process payment transactions.

It should be noted that, while sub-components of PPIV system/service 110 are depicted in FIG. 1, this arrangement of the PPIV system/service 110 into components is exemplary only; other physical and logical arrangements of a PPIV system/service 110 capable of performing the operational aspects of the disclosed techniques are possible. Various types of physical or virtual computing systems may be used to implement the PPIV system/service 110 such as server computers, desktop computers, cloud compute server environments, laptop computers, tablet computers, or any other suitable computing appliance. When implemented using a server computer, any of a variety of servers may be used including, but not limited to, application servers, database servers, mail servers, rack servers, blade servers, tower servers, virtualized servers, or any other type of server, variation of server, or combination thereof. A computing system or device may be used in some environments to implement a PPIV system/service 110. Further, it should be noted that aspects of the PPIV system/service 110 may be implemented on more than one device.

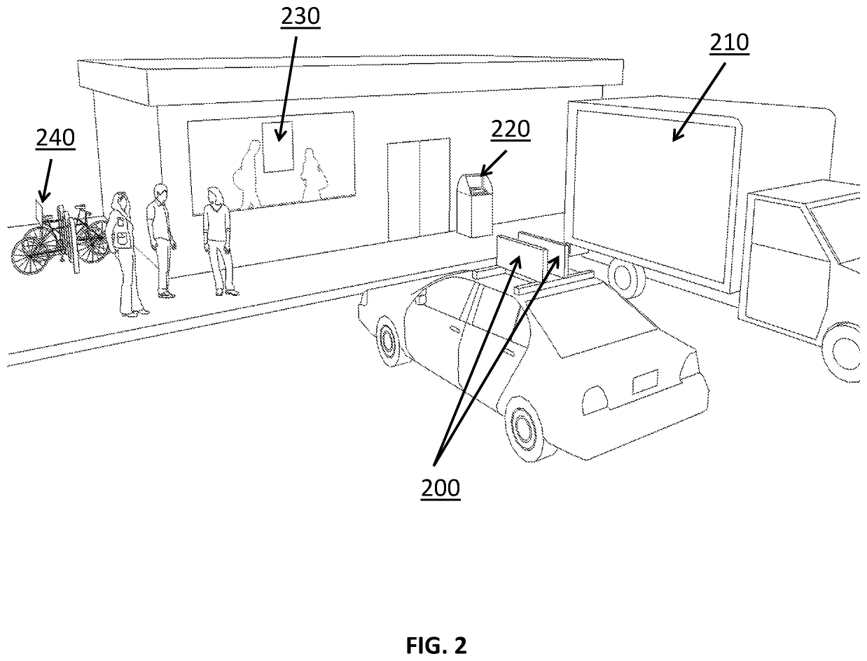

FIG. 2 shows various examples of media display systems 170 for which a PPIV charging model could be implemented. Each of the media display system 170 examples shown in FIG. 2 include one or more audio visual displays, object sensors, processing system, interface system, neural network, and AI/ML hardware either locally or remotely. These components work in combination to provide media display sessions and monitor audience viewership of said sessions. The first example depicts a media display system affixed to an automobile 200. The second example shows a media display system embedded within the side of a truck 210. The third example demonstrates a media display system in the form of a kiosk 220. The fourth example provides a wall-mounted media display system 230 located within a place of business. The fifth example illustrates a media display system attached to a bicycle 240. Each of the media display systems 170 depicted in FIG. 2 connect to the PPIV system/service 110 via network 140. These embodiments are merely examples of different media display systems 170 and are not meant to be limiting in any regards. Other media display systems 170 such as digital billboards, mobile devices, and computers can also be included in an example embodiment so long as they contain the primary components detailed above, including at least an audiovisual display and an object sensor, such as a camera.

Objects that account for audience viewership include people, mobile vehicles or other modes of transport, along with people contained within mobile vehicles or other modes of transport. Object viewership can be detected by identifying a front or side angle of an object. For example, headlights of a car or eyes on a person's face could indicate a view. Object view obstruction could also play into whether or not an audience view can be inferred reliably. For example, debris detected between the object and the display could potentially disable the possibility of a viewership. Therefore, in this specific instance the view could be rejected, have a discounted cost, or rely on further analysis for determining an appropriate cost. With all of the variables associated with each audience view, many different price outcomes can be derived for each view.

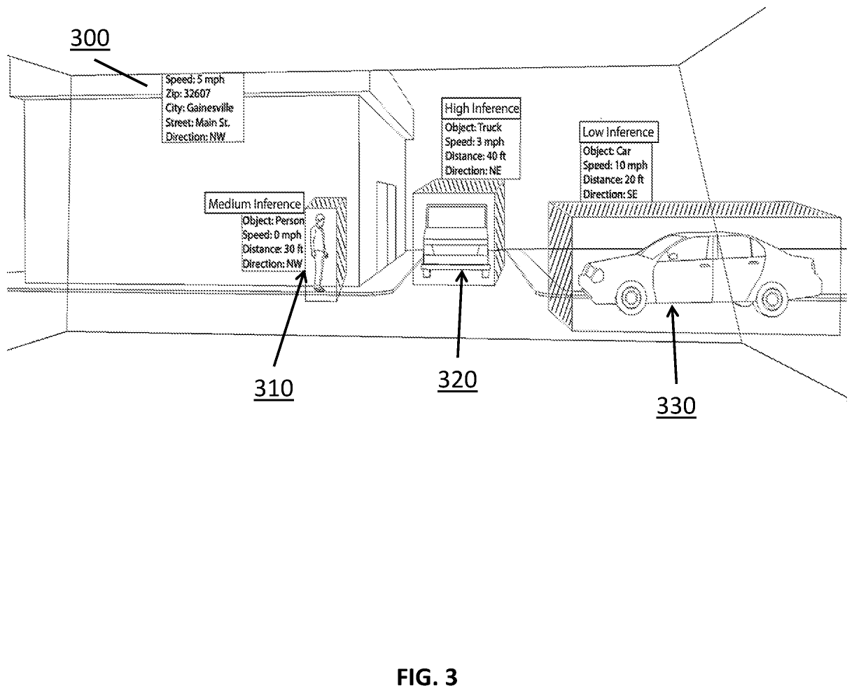

FIG. 3 shows an example embodiment of a media display system 170 from an outward viewpoint perspective. Media display system data 300 can be shown to track the media display system 170 speed, zip code, city, street, and direction. Objects including people and automobiles are shown to be detected as audience views along with notable viewership information. Object attributes such as inference rating, object type, speed, distance from the media display system 170, and direction are shown to be detected by the media display system 170. Each of these attributes can be analyzed along with other attributes not detailed, such as demographics or duration of the view, to rank or score each unique view. These ranks or scores will ultimately dictate the cost or PPIV for each viewership and then summed to obtain a total cost for the media display session. The person 310 detected was ranked as a medium inference view since they were not looking directly at the media display system 170. The truck 320 detected was ranked to be a high inference view considering that it's facing directly towards the media display system 170 and it's a high likelihood that the driver of the truck would be looking at the media display system 170, at least briefly. The car 330 detected was ranked as a low inference view due to its position and speed relative to the media display system 170. Another example for a high inference view could include an audience object directly facing the digital media display system 170 with a low speed and close proximity. A high inference view would equate to a higher cost than that of a medium or low inference view. An audience objects that meets demographic requests from a media owner/purchaser would also equate to a higher cost than that of an audience object that falls outside of the media owner/purchaser's demographic request. Another example for a low inference view cost would be an object slightly facing the digital media display system 170 and only within a viewing angle for a brief amount of time.

Identifying audience viewership for mobile media display systems 170, such as a digital billboard affixed to a mobile vehicle, can be difficult due to the media display system 170 and audience's movement patterns. A potential media viewer could be looking in the direction of a display, but not necessarily at the display. Therefore, views must be inferred and not guaranteed. This inference is made by fusing data collected by the media display system 170 and one of the most important data points is the video footage, which can be obtained from a camera. This data can be analyzed by a neural network consisting of one or more trained AI/ML models. Specifically, at least one AI/ML model trained for visual object detection and/or classification. Frame-by-frame video analysis could be used to detect people and/or vehicles facing directions positioned towards a media display system 170. Other data points can include proximity, the speed of audience compared to the speed of the media display system 170, the duration of a detected audience view, or display view obstruction instances, such as weather or debris blocking the media display view from potential audience viewership. These data points fused together help to derive an individual rank for each view. The total views along with their ranks are collated and sent with the media display session package to a host system. This data along with the media display session, media display system 170, and media owner/purchaser information gets stored on the host system, which can be accessed by media owner/purchaser users and media display system 170 users.

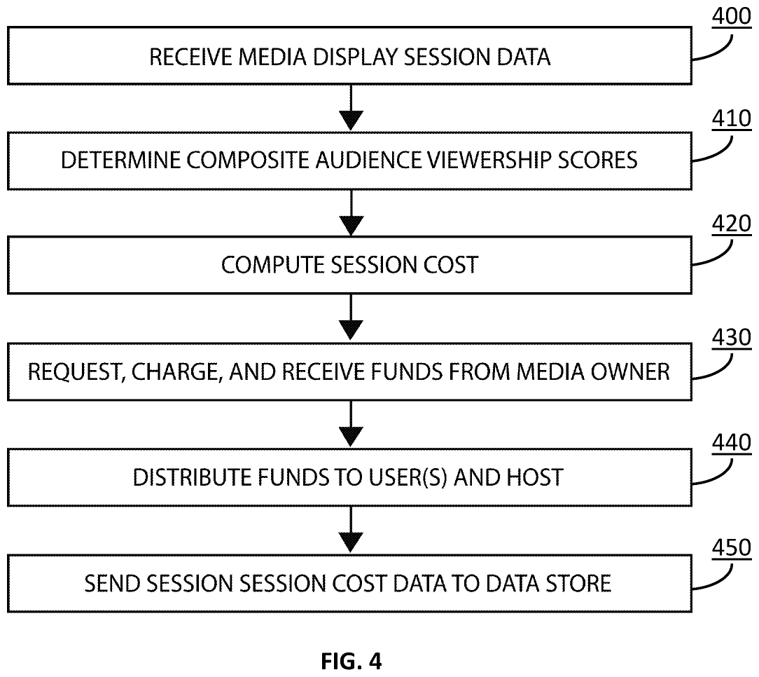

FIG. 4 shows an exemplary process flow for which a PPIV charging model could be implemented. Each of these steps could also be accomplished in a standalone manner and the order of these steps could also be rearranged to accomplish the same purpose. The first step in the process, receive media display session data 400, includes receiving audience viewership data from a media display system 170 that was processed by a neural network to identify audience viewership from a media display session. The second step in the process, determine composite audience viewership scores 410, includes analyzing all of the data points, such as an object's direction, view duration, speed, and demographics, from the media display session data and determining a score or rank for each unique audience view. Higher scores or ranks would be assigned to views that include desirable factors that would contribute to a higher engagement level from an audience viewer. The third step in the process, compute session cost 420, includes the translation from the each unique audience view score or rank into a monetary value and the addition of all the monetary values that equates to a total session cost. The fourth step in the process, request, charge, and receive funds from media owner 430, includes requesting the monetary amount dictated by the total session cost derived from the previous step, charging the media owner's account the requested monetary amount, and receiving the monetary amount. The fifth step in the process, distribute funds to user(s) and host 440, includes the distribution of the funds collected from the previous step to the user or user's accounts that were responsible for displaying the media display session on a media display system 170. This step also includes the distribution of funds to the host or service provider. The sixth and final step in the process, send session cost data to data store 450, includes taking all of the data generated in the previous steps and saving it at least one data store. Certain process flow steps could be omitted or used interchangeably in other embodiments of this system.

In certain embodiments of this system, the cost service 130, which is responsible for assigning a monetary value to a media display session, could use various factors to determine individual viewership cost as well as total media display session cost. Factors other than specific object/audience data could be included within the cost service 130 algorithm. Example factors include but not limited to time and location. For instance, certain geographical areas could be considered high value due to certain demographics or audiences that are expected to frequent said geographical areas. Certain time frames, such as 4:00-6:00 could be considered high value on roadways since more vehicles are present during rush hour. Therefore, any audience view obtained within high value geographical areas or high value time frames could be associated with a higher cost.

People or vehicles that are not facing towards a media display system 170 could either be discounted or assigned a lower inference value, which would ultimately be little to no cost to a media display session. The neural network can infer a positive view by identifying the side or frontal portion of a person or a vehicle. This helps to give inferred, actual viewership data, which is beneficial to media owners/purchasers. This data can help media owners/purchasers to better understand which of their media is attracting audiences and in which specific locations to place their media for future display sessions.

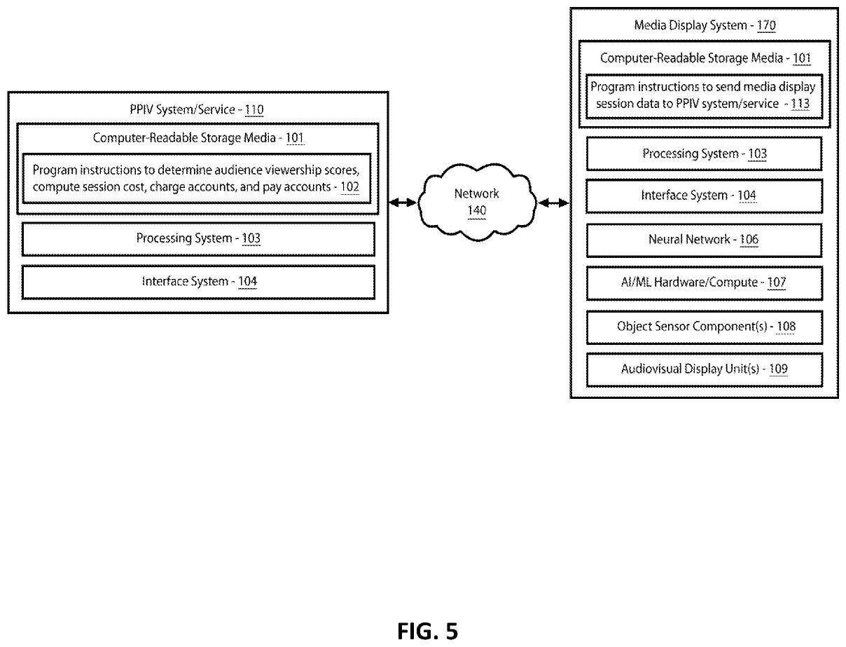

FIG. 5 shows an example embodiment of a system/component environment in which some implementations of systems and techniques for a PPIV charging model can be implemented. PPIV system/service 110 represents the server side system or service that is responsible for receiving data from a media display system 170 and processing said data for the PPIV charging model. Computer-readable storage media 101 represents a storage medium including but not limited to a hard drive, USB flash drive, or memory that can store data, specifically program instructions to determine audience viewership scores, compute session cost, charge accounts, and pay accounts 102. The program instructions 102 include the important operating commands required to perform the PPIV charging model processes. The processing system 103 executes the program instructions 102 and it can include one or more central processing unit (CPU), graphics processing unit (GPU), tensor processing unit (TPU), quantum processing unit (QPU), or photonic processing unit (PPU). The interface system 104 represents a communications interface such as a network interface card (NIC), wireless interface card, or satellite interface card that can communicate over a network 140 such as the Internet. In this example embodiment, an interface system 104 exists in both the PPIV system/service 110 and the media display system 170. In other embodiments, the interface system 104 could only exist in either the PPIV system/service 110 or only the media display system 170.

The media display system 170, as viewed in FIG. 5, represents a client-side system that displays digital media content on an audiovisual display unit 109, such as a monitor or tablet screen. In this embodiment, the processing system 103 exists in both the PPIV system/service 110 and the media display system 170. In other example embodiments, such as an embodiment that utilized cloud computing, the processing system 103 could only exist within either the PPIV system/service 110 or the media display system 170. In this example, the media display system's 170 processing system 103 executes program instructions to send media display session data to PPIV system/service 113, which are stored on computer-readable storage media 101. Neural network 106 represents an AI/ML neural network trained to identify potential audience objects through one or more object sensor components 108, such as a camera operative unit, RADAR unit, or LIDAR unit. In other example embodiments, a neural network 106 and AI/ML hardware/compute 107 could exist within the PPIV system/service 110 to process media display session costs. AI/ML hardware/compute 107 represents processing hardware such as one or more central processing unit (CPU), graphics processing unit (GPU), tensor processing unit (TPU), quantum processing unit (QPU), or photonic processing unit (PPU) dedicated to processing a neural network 106.

A communications interface may be used to provide communications between systems, for example over a wired or wireless network 140 (e.g., Ethernet, WiFi, a personal area network, a wired area network, an intranet, the Internet, Bluetooth, etc.). The communications interface may be composed of several components, such as networking cards or modules, wiring and connectors of various types, antennae, and the like. Synchronized tablets may communicate over a wireless network such as via Bluetooth, Wi-Fi, or cellular.

Object sensors component(s) 108 could be represented in various forms and combinations. Likely components would include cameras, RADAR, or LIDAR units. Various kinds of data points relevant to audience estimation are collected during the accessing of the object sensor(s) via their respective APIs/interfaces. For example, the type, direction, speed, and proximity of objects near the mobile vehicle conveying the digital media display medium may be collected. Data points from different types and numbers of object sensor(s) may be combined in some embodiments to obtain the data points relevant to audience estimation.

Camera components implement the visual imagery data-gathering aspect for performing audience detection, e.g., detection of the existence of human observers of the media via the periodic capturing of images and/or video, the process of which capturing is described. In some embodiments, images and/or video captures from camera components are used to classify objects into object types that are relevant to audience estimation. For example, images and video captures may be analyzed to perform face identification and eye gaze tracking within the image or videos, indicating the presence of an audience member within viewing range of the selected media.

LIDAR object sensor(s) can be used to very accurately determine the distance of an object from the LIDAR sensor. In some cases, object type analysis can be performed using LIDAR data. Different types of LIDAR include, for example, mechanical LIDAR and solid state LIDAR.

RADAR-type object sensor(s) can be used to determine the speed, distance, and/or direction of objects near a digital media display medium. In some embodiments, RADAR data may be analyzed to determine the shape of objects in order to classify them by object type.

For example, LIDAR object sensor(s) can be used to very accurately determine the distance of an object from the LIDAR sensor. In some cases, the type of object being detected can be analyzed via LIDAR data. For example, segmentation of objects from raw LIDAR data can be performed, in its simplest aspect, by analyzing the 2D LIDAR data using L-shapes or bounding boxes and verifying them against simple rules. Additional LIDAR-data techniques may be used to obtain 3D data points from the LIDAR sensor and segment them into candidate object type classes separate from the background field.

RADAR-type object sensor(s) can be used to determine the speed, distance, and/or direction of objects near the mobile vehicle conveying the media display client system. In some embodiments, RADAR data may be analyzed to determine the shape of objects in order to classify them by object type. Classification of object types by RADAR data can be performed, for example, by comparing the known RADAR signatures of target object types (e.g., pedestrians, automobiles, motorcycles, bicycles, trucks, etc.) to the RADAR data signature from the object sensor(s).

Images and/or video captures may be used to classify objects that are relevant to audience estimation. Classification of object types by image or video data can be performed, for example, by comparing the known image patterns of target object types (e.g., pedestrians, automobiles, motorcycles, bicycles, trucks, etc.) to the images or videos collected by the camera components. Images and video captures may be analyzed to perform face identification within the image or videos, indicating the presence of an audience member within viewing range of the selected media. For example, anonymous video analytic (AVA) software allows counting of faces without violating the privacy of persons in the image or determining the identity of particular persons.

Images and/or video analysis may be used to monitor for object obstruction. The presence of obstructions might impact an audience's viewing of the selected media, e.g., a truck passing on the right side of the mobile vehicle might block the visibility of the right-side audiovisual display unit(s) 109 to pedestrians; a street sign, hill, highway barrier wall, parked automobiles, trees, bushes/foliage, the walls of buildings or yards, and other landscape features might block the viewing of one or more audiovisual display unit(s) 109.

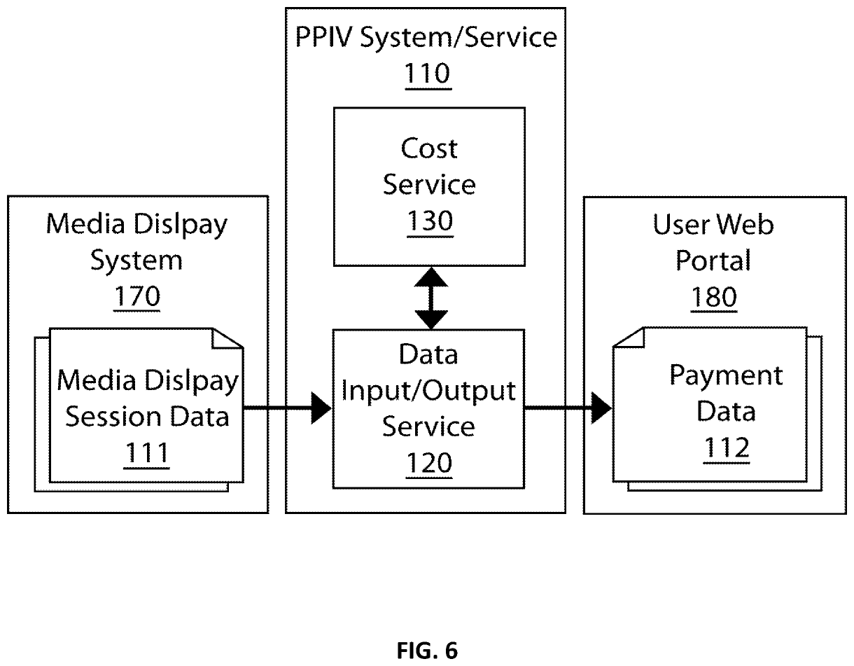

FIG. 6 shows an example embodiment of a high-level process flow for a PPIV charging model. The three major components of this system including media display system 170, PPIV system/service 110, and user web portal 180 are shown interacting with each other to execute the PPIV charging model described herein. Initially, the media display system 170 packages media display session data 111, which includes audience viewership data, and delivers said data to the PPIV system/service 110. Specifically, the media display session data 111 is delivered to the data input/output service 120, which is responsible for sending and receiving data between all of the system components. Next, the data input/output service 120 send the media display session data to the cost service 130, which is responsible for determining audience viewership scores, computing a media display session cost, charging media owner accounts, and paying media display and service provider accounts. Finally, the payment data 112 derived from the previous step, which contains at least media display session pricing information as well as payment information, is delivered to the user web portal 180 via the data input/output service 120. Both media owner and media display users can view the payment data 112 within the user web portal 180.

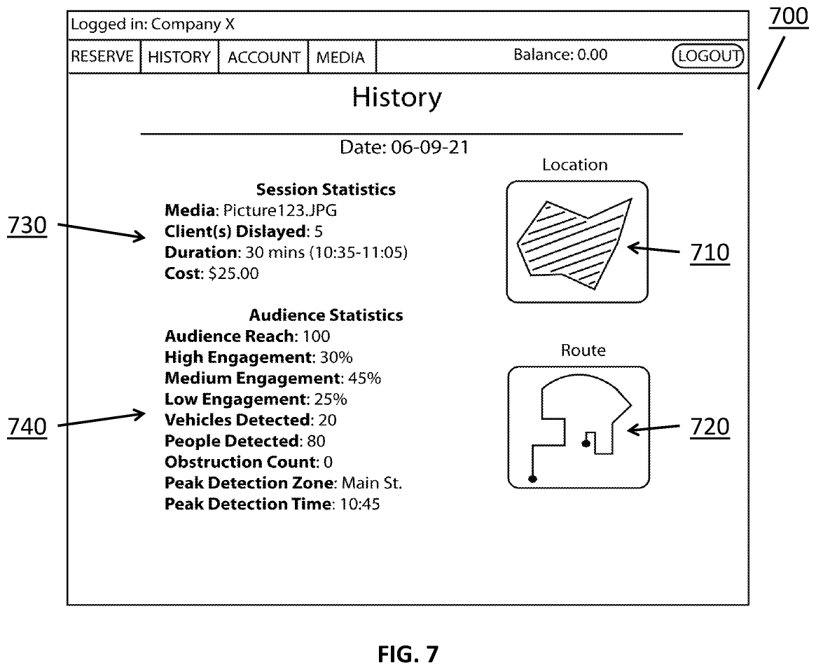

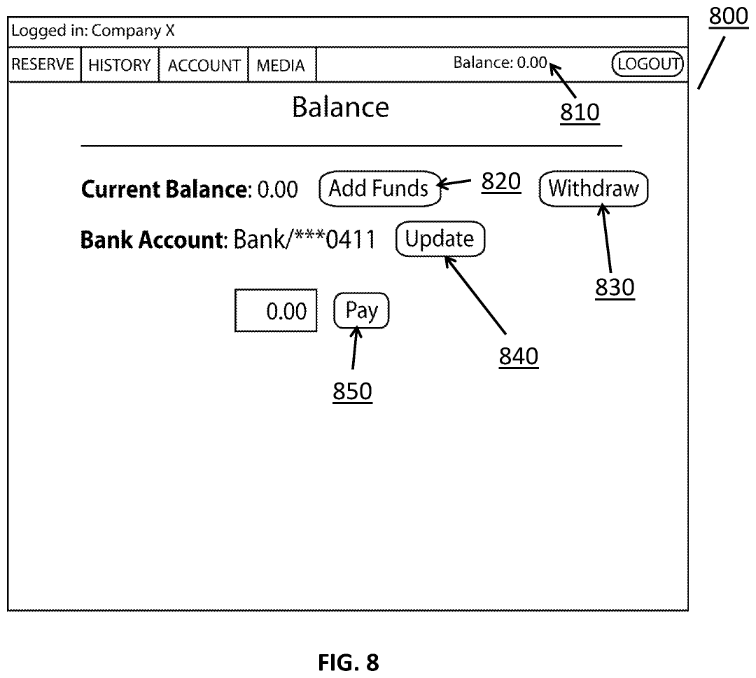

FIG. 7-8 shows examples of a user web portal 180 interfaces. These interfaces could be accessed through the Internet via a desktop application, mobile application, or web browser. These interfaces could also be used to view media display session data or pay for costs incurred from previous or future media display sessions.

FIG. 7 shows an example user web portal history screen/interface 700. The specific content displayed within this example embodiment pertains to previous media display session data. Either a media owner or media display user-operator could view this data. However, this specific data would be more likely to only be viewed by a media owner considering that it provides details that would only be relevant to a media owner, such as the total number of clients in which a media display session displayed a media owner's media. Some example session statistics 730 that could be provided to a media owner could include the specific media that was displayed during the media display session, the total amount of media display systems 170 that displayed the media display session, the total duration in which the media display session was displayed, and the total cost for the media display system 170. Some example audience statistics 740 that could be provided to a media owner could include total audience reach, the percentage of the total audience reach that received a high, medium, or low engagement score, the total amount of people and vehicles detected, the amount of object obstruction that potentially prevented the media display from being seen from viewers, and the peak zones and times in which the media display session received the most viewership or engagement. Other potential data that could be viewed through the user web portal interface 700 could include location 710 and route 720 data in which the media display system 170 traveled while displaying the media display session. All of this data could provide media owners with pertinent information that could allow them to spend advertisement dollars more wisely and target certain geographic locations more precisely. This representation of a history screen is exemplary only and not intended to be limiting. More or less data can be added or subtracted from this history screen.

FIG. 7 shows an example user web portal balance screen/interface 800. The specific content displayed within this example embodiment pertains to a user's financial data. This interface would provide user-operators with the capabilities to view their account balance 810, which could be in a monetary or credit/token form, add funds 820 or withdraw funds 830 to and from their account, update 840 their banking or financial resource information, or pay 850 outstanding bills associated with their account. This representation of a balance screen is exemplary only and not intended to be limiting. More or less data can be added or subtracted from this balance screen.

In some embodiments, data derived from a media display system 170 as well as data derived from the PPIV system/service 110, including user-operator account data may be stored on the PPIV system/service 110 within a user store 160 and a session store 150, as described in regard to FIG. 1. Each data store may be organized and stored on the computer-readable storage media in any manner that can be readily understood by a processing system and/or software thereon. In some example embodiments, records or tables in a relational or NoSQL database may be used to persistently store the data stores; in other embodiments, an operating system file with an XML or JSON format or having a custom storage structure can be used to organize the data stores. Combinations of these techniques in association with files in a file system may be used.

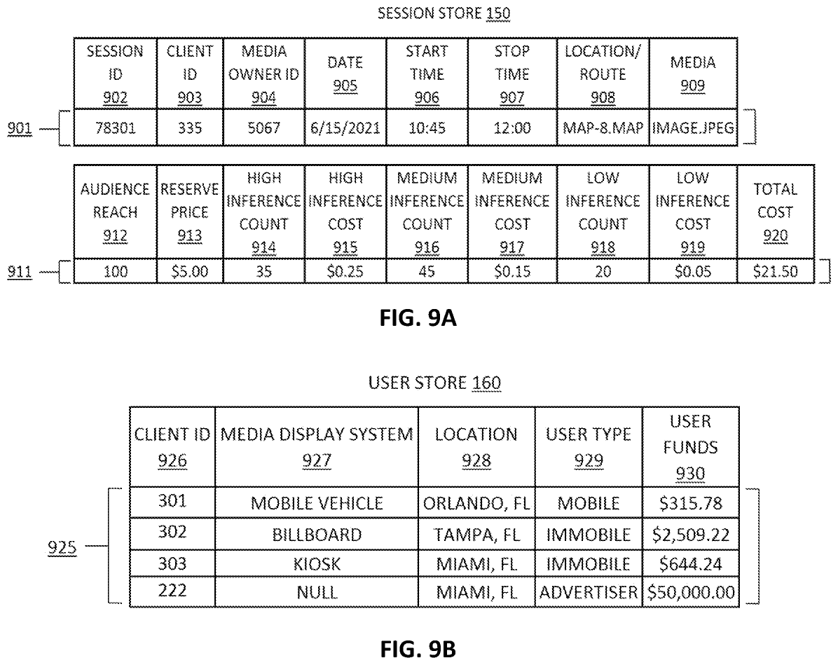

FIG. 9A shows an example representation of a session store 150, organized as a table in a relational database. Data contained within this data store includes information related to media, audience viewership statistics, and cost data attributed to a media display session. In FIG. 9A, data properties are shown as attribute columns, with each non-header row denoting a media reference and its data properties. Attribute columns may include, for example session ID 902, which is the unique identifier for the media display session, client ID 903, which is the unique identifier for the media display system 170, media owner ID 904, which is the unique identifier for the user account that owns the media, date 905, which is the date in which the media display session occurred, start time 906, which is the time that the media display session began, stop time 907, which is the time that the media display session ended, location/route 908, which is the geographical location and route data in which the media display system 170 traveled during the media display session, and the media file referent 909. The media itself may be stored in the file system with a referent (e.g., 909) to the media file name in the session store 150. Example records 901 include various data properties associated with each media reference, such as (IMAGE.JPEG), which represents media data from the media display session.

Further attribute columns may include, for example audience reach 912, which is the total amount of audience views that were detected in the media display session, reserve price 913, which is the flat fee associated with reserving the media display session, high inference count 914, which is total audience views that were inferred to be of high value, high inference cost 915, which is the total cost associated with the high inference views, medium inference count 916, which is total audience views that were inferred to be of medium value, medium inference cost 917, which is the total cost associated with the medium inference views, low inference count 918, which is total audience views that were inferred to be of low value, low inference cost 919, which is the total cost associated with the low inference views, and total cost 920, which is the total cost associated with the media display session that will be charged to one or more media owner. Example records 911 include various data properties associated with each media reference, such as ($21.50), which represents monetary data associated with the media display session. This representation of a session store 150 is exemplary only and not intended to be limiting. More or less data fields can be added or subtracted from this data store.

FIG. 9B shows an example of a user store 160, organized as a table in a relational database. In FIG. 9B, data properties are shown as attribute columns, with each non-header row denoting user/media display system data properties. Attribute columns may include, for example, client id 926, which is the unique client identification number, media display system 927, which is the media display system descriptor, location 928, which is the geographical location in which the media display session occurred within, user type 929, which is the user descriptor, and user funds 930, which is the amount of monetary funds or credits associated with the user account. Example records 925 include various data properties associated with each user column header, such as (ADVERTISER), which represents an advertiser or media owner user account. This representation of a user store is exemplary only and not intended to be limiting. More or less data fields can be added or subtracted from this data store.

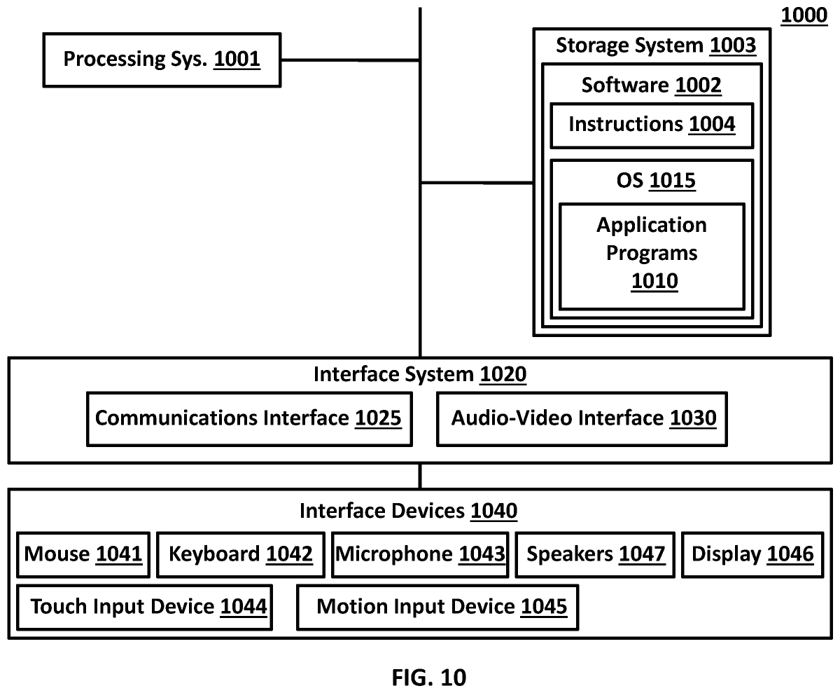

FIG. 10 shows a block diagram illustrating components of a computing device or system used in some embodiments of techniques and systems for facilitating data analysis and application of classification markings. Any component utilizing a computing system or device herein, or any other device or system herein may be implemented on one or more systems as described with respect to system 1000. System 1000 can be used to implement myriad computing devices, including but not limited to a personal computer, a tablet computer, a reader, a mobile device, a personal digital assistant, a wearable computer, a smartphone, a laptop computer (notebook or netbook), a gaming device or console, a desktop computer, or a smart television. Accordingly, more or fewer elements described with respect to system 1000 may be incorporated to implement a particular computing device.

System 1000 can itself include one or more computing systems or devices or be distributed across multiple computing devices or sub-systems that cooperate in executing program instructions. The hardware can be configured according to any suitable computer architectures such as Symmetric Multi-Processing (SMP) architecture or Non-Uniform Memory Access (NUMA) architecture.

The system 1000 can include a processing system 1001, which may include one or more processors or processing devices such as a central processing unit (CPU), a graphics processing unit (GPU), a tensor processing unit (TPU), a quantum processing unit (QPU), a photonic processing unit (PPU) or microprocessor and other circuitry that retrieves and executes software 1002 from storage system 1003. Processing system 1001 may be implemented within a single processing device but may also be distributed across multiple processing devices or sub-systems that cooperate in executing program instructions.

Examples of processing system 1001 include general-purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general-purpose CPU.

Storage system 1003 may comprise any computer-readable storage media readable by processing system 1001. Storage system 1003 may include volatile and nonvolatile, removable and nonremovable media implemented in any method or technology for storage of information, such as computer readable instructions, data structures, program modules, or other data. Examples of storage media include random access memory (RAM), read only memory (ROM), magnetic disks, optical disks, write-once-read-many disks, CDs, DVDs, flash memory, solid state memory, phase change memory, 3D-XPoint memory, or any other suitable storage media. Certain implementations may involve either or both virtual memory and non-virtual memory. In no case do storage media consist of a transitory propagated signal. In addition to storage media, in some implementations, storage system 1003 may also include communication media over which software 1002 may be communicated internally or externally. Storage system 1003 may be implemented as a single storage device but may also be implemented across multiple storage devices or sub-systems co-located or distributed relative to each other. Storage system 1003 may include additional elements capable of communicating with processing system 1001.

Storage system 1003 is capable of storing software 1002 including, e.g., program instructions 1004. Software 1002 may be implemented in program instructions and, among other functions, may, when executed by system 1000 in general or processing system 1001 in particular, direct system 1000 or processing system 1001 to operate as described herein. Software 1002 may provide program instructions 1004 to perform the processes described herein. Software 1002 may implement on system 1000 components, programs, agents, or layers that implement in machine-readable processing instructions 1004 the methods and techniques described herein.

Application programs 1010, OS 1015 and other software may be loaded into and stored in the storage system 1003. Application programs could include AI/ML software such as a neural network, models, or training software. Device operating systems 1015 generally control and coordinate the functions of the various components in the computing device, providing an easier way for applications to connect with lower level interfaces like the networking interface. Non-limiting examples of operating systems include Windows® from Microsoft Corp., (OS™ from Apple, Inc., Android® OS from Google, Inc., Windows® RT from Microsoft, and different types of the Linux OS, such as Ubuntu® from Canonical or the Raspberry Pi OS. It should be noted that the OS 1015 may be implemented both natively on the computing device and on software virtualization layers running atop the native Device OS. Virtualized OS layers, while not depicted in this Figure, can be thought of as additional, nested groupings within the OS 1015 space, each containing an OS, application programs, and APIs.

In general, software 1002 may, when loaded into processing system 1001 and executed, transform system 1000 overall from a general-purpose computing system into a special-purpose computing system customized to facilitate the processes described herein. Indeed, encoding software 1002 on storage system 1003 may transform the physical structure of storage system 1003. The specific transformation of the physical structure may depend on various factors in different implementations of this description. Examples of such factors may include, but are not limited to, the technology used to implement the storage media of storage system 1003 and whether the computer-storage media are characterized as primary or secondary storage. Software 1002 may include software-as-a-service (SaaS) loaded on-demand from a cloud service. Software 1002 may also include firmware or some other form of machine-readable processing instructions executable by processing system 1001. Software 1002 may also include additional processes, programs, or components, such as operating system software and other application software.

System 1000 may represent any computing system on which software 1002 may be staged and from where software 1002 may be distributed, transported, downloaded, or otherwise provided to yet another computing system for deployment and execution, or yet additional distribution. System 1000 may also represent other computing systems that may form a necessary or optional part of an operating environment for the disclosed techniques and systems.

An interface system 1020 may be included, providing interfaces or connections to other computing systems, devices, or components. Examples include a communications interface 1025 and an audio-video interface 1030, which may be used to interface with components as described herein. Other types of interface (not shown) may be included, such as power interfaces.

A communications interface 1025 provides communication connections and devices that allow for communication between system 1000 and other computing systems (not shown) over a communication network or collection of networks (not shown) or the air. Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here. Transmissions to and from the communications interface may be controlled by the OS 1015, which informs applications and APIs of communications events when necessary.

It should be noted that many elements of system 1000 may be included in a system-on-a-chip (SoC) device. These elements may include, but are not limited to, the processing system 1001, a communications interface 1025, audio-video interface 1030, interface devices 1040, and even elements of the storage system 1003 and software 1002.

Interface devices 1040 may include input devices such as a mouse 1041, track pad, keyboard 1042, microphone 1043, a touch device 1044 for receiving a touch gesture from a user, a motion input device 1045 for detecting non-touch gestures and other motions by a user, and other types of input devices and their associated processing elements capable of receiving user input.

The interface devices 1040 may also include output devices such as display screens 1046, speakers 1047, haptic devices for tactile feedback, and other types of output devices. In certain cases, the input and output devices may be combined in a single device, such as a touchscreen display, which both depicts images and receives touch gesture input from the user. Visual output may be depicted on the display 1046 in myriad ways, presenting graphical user interface elements, text, images, video, notifications, virtual buttons, virtual keyboards, or any other type of information capable of being depicted in visual form. Other kinds of user interfaces are possible. Interface devices 1040 may also include associated user interface software executed by the OS 1015 in support of the various user input and output devices. Such software assists the OS in communicating user interface hardware events to application programs 1010 using defined mechanisms.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

It should be understood that the examples and embodiments described herein are for illustrative purposes only and that various modifications or changes in light thereof will be suggested to persons skilled in the art and are to be included within the spirit and purview of this application.

Although the subject matter has been described in language specific to features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

Certain features that are described in this disclosure in the context of separate embodiments can also be implemented in combination in a single embodiment. Conversely, various features that are described in the context of a single embodiment can be implemented in multiple embodiments separately or in various suitable subcombinations. Also, features described in connection with one combination can be excised from that combination and can be combined with other features in various combinations and subcombinations. Various features can be added to the example embodiments disclosed herein. Also, various features can be omitted from the example embodiments disclosed herein.

When “or” is used herein, it is intended to be used according to its typical meaning in logic, in which both terms being true (e.g., present in an embodiment) also result in configurations having an affirmative truth value. If the “XOR” meaning is intended (in which both terms being true would result in a negative truth value), “xor” or “exclusive or” will be explicitly stated.

Similarly, while operations are depicted in the drawings or described in a particular order, the operations can be performed in a different order than shown or described. Other operations not depicted can be incorporated before, after, or simultaneously with the operations shown or described. In certain circumstances, parallel processing or multitasking using separate processes or threads within an operating system may be used. Also, in some cases, the operations shown or discussed can be omitted or recombined to form various combinations and subcombinations.

What is claimed is:

1. A system and method for assigning a monetary cost for digital media display sessions through a pay-per-inferred-view charging model, comprising:
a non-transitory computer-readable storage medium;
a processing system;
one or more media display systems, wherein the one or more media display systems comprises a neural network;
an interface system, including a communications interface, wherein the interface system communicates with the one or more media display systems; and
program instructions stored on the computer-readable storage medium that, when executed by the processing system, direct the processing system to:
in response to receiving, via the communications interface, media display session data from the media, display system, wherein the media display session data includes at least audience viewership information:
identify one or more unique audience entity from the audience viewership information;
determine an audience entity quality rating for each unique audience entity;
determine composite audience viewership scores from the audience entity quality rating for each unique audience entity; and
compute a session cost for the media display session.

2. The system of claim 1, comprising further instructions that when executed by the processing system, further direct the processing system to:
calculate a demographic factor for each unique audience entity; and
use the demographic factors to adjust an individual value factor for each audience entity quality rating in accordance with targeting properties of the media display session.

3. The system of claim 1, wherein each unique audience view can have a unique monetary cost.

4. The system of claim 1, comprising further instructions that when executed by the processing system, further direct the processing system to:
in response to calculating a session cost:
charge or request monetary funds or credits from a media owner user account associated with advertisement media displayed within the media display session.

5. The system of claim 1, comprising further instructions that when executed by the processing system, further direct the processing system to:
in response to receiving monetary funds or credits from the media owner user account:
distribute monetary funds or credits to one or more client user accounts or entities associated with the media display system which hosted the media display session.

6. The system of claim 1, comprising further instructions that when executed by the processing system, further direct the processing system to,
in response to receiving monetary funds or credits from the media owner user account,
distribute monetary funds or credits to an entity associated with hosting the system.

7. The system of claim 1, comprising further instructions that when executed by the processing system, further direct the processing system to:
send the session cost for the digital media display session to a data store, wherein said data store provides session cost data to a web host that allows users to view the session cost.

8. The system of claim 1, wherein the audience viewership data was processed with a neural network trained with artificial intelligence/machine learning visual inference models to infer each unique audience view.

9. The system of claim 8, wherein the neural network ranked each unique audience view.

10. The system of claim 8, wherein the neural network uses frame-by-frame video analysis and a labeled data set to infer audience views.

11. The system of claim 1, wherein the audience views consist of at least one of people and mobile vehicles.

12. The system of claim 1, wherein the media display system is affixed to a mobile vehicle.

13. The system of claim 12, wherein the mobile vehicle is an automobile, a flying drone, a land-based drone, a water-based drone, or a public transport, wherein the public transport is a bus, shuttle, or train.

14. The system of claim 1, wherein the media display system is an immobile digital billboard or kiosk.

15. The system of claim 1, wherein the media display system comprises one or more digital display screens and one or more cameras.

16. The system of claim 1, wherein the media display system is a mobile phone, tablet, television, or computing device.

17. The system of claim 1, wherein the system further comprises a neural network, wherein the neural network performs the audience viewership scoring and session cost calculation.

18. The system of claim 1, wherein one or more media owner user accounts are associated with a media display session.

19. The system of claim 1, wherein the media display session data includes at least audience viewership data.
